(19) United States
(12) Patent Application Publication
(10) Pub. No.: US 2008/0140875 A1
(43) Pub. Date: Jun. 12, 2008

(54) Data access method

(75) Inventor: Kun-Hui Chuo, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/638,065

(22) Filed: Dec. 12, 2006

(51) Int. Cl. G06F 13/28

(52) U.S. Cl. 710/22

(57) ABSTRACT

A data access method for use in a system driver of a computer system using direct memory access (DMA) for data transmission between the system driver, a device in the computer system, and random access memory (RAM) includes the steps of requesting the computer system for a predetermined number of logic memory blocks and corresponding DMA memory blocks during initialization of the system driver to form a predetermined number of storage units, loading data structures of the storage units with pointers of the logic memory blocks and corresponding DMA memory blocks, and creating a global pointer pointing to a data table stored with usage statuses of the storage units. Accordingly, the system driver transmits data by the storage units directly without having to wait for responses from the computer system, thus enabling the system driver to perform data access fast.

### BACKGROUND OF THE INVENTION

1. Field of the Invention

The present invention relates to data access techniques, and more particularly, to a data access method for use in a system driver of a computer system.

2. Description of the Prior Art

Computer system designers and manufacturers consider it important to enable a computer system, such as a personal computer, notebook computer, or server, to operate by means of a data access method efficiently.

Among various computer systems, some data storage devices, such as harddisk drive and CD-ROM drive, are important hardware devices for storing programs or data indispensable to the operation of a computer system. Data access takes place between a system driver of the computer system and a storage device of the computer system in two ways, namely Program Input/Output (PIO) and Direct Memory Access (DMA). PIO entails performing data access in the control of a central processing unit (CPU); a system driver running in the CPU executes data access and thereby using plenty of resources otherwise available to the CPU, and in consequence the computer system overworks. DMA entails performing data access in the control of a DMA controller but in a way free of intervention from the CPU; with DMA, the computer system operates efficiently, as the CPU is not overloaded. Owing to the aforesaid advantages, DMA is in wide use.

To perform DMA-based data access between a system driver and a data storage device like a hardisk drive, the driving system has to request the computer system for one or more logic memory blocks for storing the data to be read or write, and then request the computer system for one or more DMA memory blocks corresponding to the logic memory blocks respectively when performing data access.

Nevertheless, the aforesaid way of performing DMA-based data access does have its own drawbacks. First, prior to execution of data access, the system driver has to take time to await requesting the computer system for a definite number of logic memory blocks and corresponding DMA memory blocks, and doing so is time-consuming and inefficient; and, more badly, the more the data to be accessed, the longer it takes to wait for data access, and the more inefficient is data access. Second, a computer system responding to more than one request for data access concurrently or processing more than one jobs concurrently always lacks memory resources, and thus a system driver of the computer system has to temporarily give up using the resources of the computer system because of a transient lack of memory blocks required; instead, the system driver has to request the computer system for resources again later on; in so doing, not only is the current data access operation likely to fail, but data access performed in such a way is inefficient because of the long wait and the repeated requests. Lastly, concurrent requests for operation execution are liable to conflict and congestion, thus overloading the computer system.

Accordingly, an issue calling for urgent solution involves providing a data access method for performing data access between a system driver and a data storage device swiftly, and sparing a long wait for memory resources assigned by the computer system as disclosed in the prior art.

### SUMMARY OF THE INVENTION

In light of the aforesaid drawbacks of the prior art, it is a primary objective of the present invention to provide a data access system and method for solving the problem arising from a system driver taking long time to wait for a computer system to respond to request for data structures of a storage unit, and solving the problem about slow data access as a result of the system driver repeating a request after a temporary silence on the request.

In order to achieve the above and other objectives, the present invention discloses a data access method for use in a system driver of a computer system using direct memory access (DMA) for data transmission between the system driver, a device in the computer system, and random access memory (RAM), the data access method comprising the steps of: (1) requesting the computer system for a predetermined number of logic memory blocks and corresponding DMA memory blocks during initialization of the system driver such that each of the logic memory blocks and a corresponding one of the DMA memory blocks together form a storage unit; (2) loading a data structure of the storage unit with a pointer of the logic memory block and a pointer of the corresponding DMA memory block; and (3) creating a global pointer pointing to a data table stored with usage statuses of the storage unit.

As regards a preferred embodiment of the present invention, the data access method of the present invention further comprises the steps of: (4) determining, before data transmission between the system driver and the device in the computer system starts, whether the storage units each having an unused status stored in the data table are enough for data transmission, proceeding to step (5) in response to an affirmative determination, and repeating the step (4) in response to a negative determination until the storage units are enough for data transmission; and (5) retrieving a sufficient amount of the storage units for data transmission, setting the usage statuses of the retrieved storage units to an in-use status, freeing the retrieved storage units upon completion of data transmission, and setting the usage statuses of the freed storage units to an unused status.

As regards a preferred embodiment of the present invention, the data access method of the present invention further comprises, before the step (1), the step of allowing the system driver to create beforehand a global variable space for recording the amount of the storage units, wherein the global variable space is disposed in the random access memory and removed therefrom when execution of the system driver ends.

In comparison with the prior art, the present invention discloses a data access method whereby a system driver of a computer system directly executes data access by means of a storage unit, sparing a long wait for a response from the computer system. Accordingly, the present invention solves the problem of slow data access facing the prior art.

### BRIEF DESCRIPTION OF THE DRAWINGS

FIG. 1 is a flow chart of execution of a data access method in accordance with the present invention; and

FIG. 2 is a flow chart of execution of data access by a system driver in accordance with a data access method of the present invention.

### DETAILED DESCRIPTION OF THE PREFERRED EMBODIMENT

The following specific embodiment is provided to illustrate the present invention. Persons skilled in the art can readily gain an insight into other advantages and features of the present invention based on the contents disclosed in this specification.

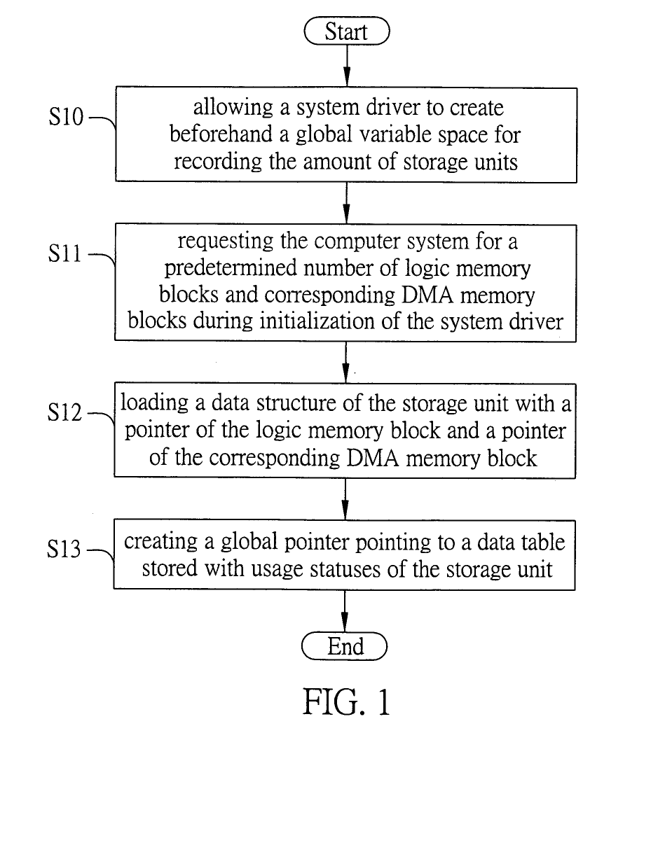

Referring to FIG. 1, which is a flow chart of execution of a data access method in accordance with the present invention, as illustrated with this embodiment, the data access method of the present invention is applicable to a system driver of a computer system using direct memory access (DMA) for data transmission between the system driver, a device in the computer system, and random access memory (RAM). The computer system of this embodiment is exemplified by a device having a data processing function, such as a palm-held computer, hand-held computer, notebook computer, personal computer, server, and workstation. The device in the computer system of this embodiment is exemplified by a data storage device like a harddisk drive. The system driver of this embodiment is exemplified by a driver for the device.

Referring to FIG. 1, step S10 involves having the system driver create beforehand a global variable space for recording the amount of the storage units. The global variable space is disposed in the random access memory and removed therefrom when execution of the system driver ends. A logic memory block and a DMA memory block corresponding thereto together form a storage unit. The number of the storage units matches that of the logic memory blocks and that of the corresponding DMA memory blocks. Proceed to step S11.

Step S11 involves requesting the computer system for a predetermined number of logic memory blocks and corresponding DMA memory blocks during initialization of the system driver. To be specific, after the computer system has executed a Power-On Self-Test (POST) and loaded the operating system, the operating system detects the computer system for any embedded or external devices, searches a storage device of the computer system for system drivers corresponding to the devices, and loads the system drivers to the operating system, so as to drive the devices by the system drivers. In this embodiment, an initialization procedure precedes the loading of a system driver, and step S11 involves requesting the computer system for a predetermined number of logic memory blocks and corresponding DMA memory blocks during initialization of the system driver. The logic memory blocks are specific locations of data storage in the random access memory (RAM). The DMA memory blocks are specific locations of data storage in the DMA mechanism corresponding to the random access memory (RAM).

A point to note is that, in this embodiment, the number of the logic memory blocks and the corresponding DMA memory blocks required by the system driver equals a maximum number of the logic memory blocks and the corresponding DMA memory blocks likely to be requested by the system driver corresponding to the device during execution of the system driver; doing so ensures that in the course of data transmission the system driver does not need to request the computer system for extra memory resources. The number of the logic memory blocks and the corresponding DMA memory blocks of any other embodiment of the present invention is determined as appropriate. Proceed to step S12.

Step S12 involves loading a data structure of the storage unit with a pointer of the logic memory block and a pointer of the corresponding DMA memory block. Inasmuch as each of the logic memory blocks and the corresponding DMA memory blocks has a pointer pointing to itself, step S12 recites loading a data structure of the storage unit with a pointer of the logic memory block and a pointer of the corresponding DMA memory block. In this embodiment, the data structures of the storage units are linked together by a double link list. Proceed to step S13.

Step S13 involves creating a global pointer pointing to a data table stored with usage statuses of the storage unit. In this embodiment, both the global pointer and the data table are stored in the random access memory, and the usage statuses comprise at least two statuses, namely an unused status and an in-use status.

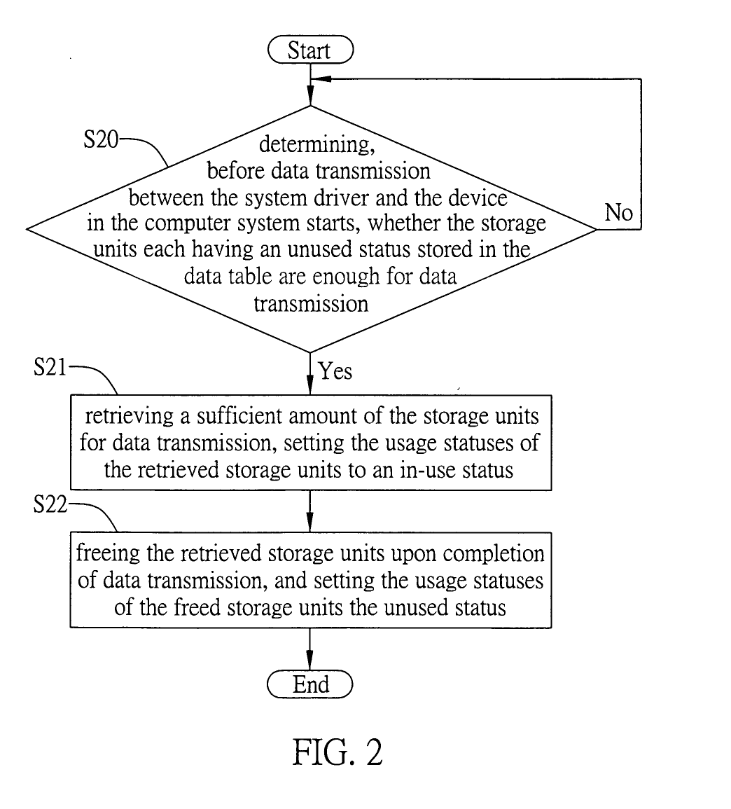

Referring to FIG. 2, which is a flow chart of execution of data access by a system driver in accordance with a data access method of the present invention, step S20 involve determining, before data transmission between the system driver and the device in the computer system starts, whether the storage units each having an unused status stored in the data table are enough for data transmission, proceeding to step S21 in response to an affirmative determination, and repeating the step S20 in response to a negative determination until the storage units are enough for data transmission.

Step S21 involves retrieving a sufficient amount of the storage units for data transmission, and setting the usage statuses of the retrieved storage units to the in-use status. Proceed to step S22 as soon as data transmission completes.

Step S22 involves freeing the retrieved storage units upon completion of data transmission, and setting the usage statuses of the freed storage units to the unused status.

Summarizing the above, a data access method of the present invention allows a system driver to transmit data by the storage units directly without having to wait for responses from a computer system, thus enabling the system driver to perform data access fast.

The aforesaid embodiment merely serves as the preferred embodiments of the present invention. The aforesaid embodiment should not be construed as to limit the scope of the present invention in any way. Hence, any other changes can actually be made in the present invention. It will be apparent to those skilled in the art that all equivalent modifications or changes made, without departing from the spirit and the technical concepts disclosed by the present invention, should fall within the scope of the appended claims.

What is claimed is:

1. A data access method for use in a system driver of a computer system using direct memory access (DMA) for data transmission between the system driver, and a device and random access memory (RAM) in the computer system, the data access method comprising the steps of:
(1) requesting the computer system for a predetermined number of logic memory blocks and corresponding DMA memory blocks during initialization of the system driver such that each of the logic memory blocks and a corresponding one of the DMA memory blocks together form a storage unit;
(2) loading a data structure of the storage unit with pointers of the logic memory block and the corresponding DMA memory block; and
(3) creating a global pointer pointing to a data table stored with usage statuses of the storage unit.

2. The data access method of claim 1, further comprising the steps of:
(4) determining, before data transmission between the system driver and the device in the computer system starts, whether the storage units each having an unused status stored in the data table are enough for data transmission, proceeding to step (5) in response to an affirmative determination, and repeating the step (4) in response to a negative determination until the storage units are enough for data transmission; and
(5) retrieving a sufficient amount of the storage units for data transmission, setting the usage statuses of the retrieved storage units to an in-use status, freeing the retrieved storage units upon completion of data transmission, and setting the usage statuses of the freed storage units to the unused status.

3. The data access method of claim 2, further comprising, before the step (1), the step of:
allowing the system driver to create beforehand a global variable space for recording the amount of the storage units, wherein the global variable space is disposed in the random access memory and removed therefrom when execution of the system driver ends.

4. The data access method of claim 1, further comprising, before the step (1), the step of:
allowing the system driver to create beforehand a global variable space for recording the amount of the storage units, wherein the global variable space is disposed in the random access memory and removed therefrom when execution of the system driver ends.

5. The data access method of claim 1, wherein a predetermined number of the logic memory blocks and the corresponding DMA memory blocks equals a maximum number of the logic memory blocks and the corresponding DMA memory blocks likely to be requested by the system driver corresponding to the device during the execution of the system driver.

6. The data access method of claim 1, wherein the data structures of the storage units are linked together by a double link list.
